(19) United States
(12) Patent Application Publication
(10) Pub. No.: US 2025/0272959 A1
(43) Pub. Date: Aug. 28, 2025

(54) REGION-AWARE VISION LANGUAGE PROCESSOR

(71) Applicant: NVIDIA Corp., Santa Clara, CA (US)

(72) Inventors: Qiushan Guo, Central and Western District (HK); Shalini De Mello, San Francisco, CA (US); Hongxu Yin, San Jose, CA (US); Wonmin Byeon, Santa Cruz, CA (US); Ka Chun Cheung, Eastern District (HK); Simon Chong-Wee See, Singapore (SG); Jan Kautz, Lexington, MA (US); Sifei Liu, San Diego, CA (US)

(73) Assignee: NVIDIA Corp., Santa Clara, CA (US)

(21) Appl. No.: 19/065,367

(22) Filed: Feb. 27, 2025

Related U.S. Application Data
(60) Provisional application No. 63/558,408, filed on Feb. 27, 2024.

(51) Int. Cl. G06V 10/771; G06V 20/70

(52) U.S. Cl. CPC G06V 10/771; G06V 20/70

(57) ABSTRACT

Visual language processors that include an image encoder configured to convert an image into a low-resolution feature map, a feature refinement network configured to upsample the low-resolution feature map into a high-resolution feature map, and a visual-language connector configured to map an image-level feature map and a region-level feature map both derived from the high-resolution feature map into an embedding space of a language encoder.

### CROSS-REFERENCE TO RELATED APPLICATIONS

This application claims priority and benefit under 35 U.S.C. 119 (e) to U.S. application Ser. No. 63/558,408, titled “RegionGPT: Towards Region Understanding Vision Language Model”, filed on Feb. 27, 2024, the contents of which are incorporated herein by reference in their entirety.

### BACKGROUND

Modern vision language models (VLMs) integrate large language models (LLMs) with image-text pairs. Conventional vision language models struggle to provide detailed regional visual interpretation due to the limited spatial awareness of the vision encoder they utilize, and because they are configured with coarse-grained training data that lacks detailed, region-specific captions.

Configuring region-level complex understanding into VLMs involves alignment of spatial information and semantics. Conventional VLMs learn regions of interest in a textual form (e.g. [x1,y1,x2,y2]) common to the model structure as that configured for image-level tasks. This approach relies on the language encoder interpreting the position while overlooking the prior positional information provided by the image encoder. Such an oversight can lead to a gap in effectively integrating visual cues with linguistic context, which may be crucial for tasks involving detailed image understanding. Some recent models utilize spatial boxes with region-of-interest aligned features and are trained specifically on region-text pairs. In these models the positional format may be restricted to a bounding box, limiting their utility and flexibility.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an example of an image with numbered regions.

FIG. 2 depicts a visual language processor in accordance with one embodiment.

FIG. 3-FIG. 7 depict more examples of images with numbered regions.

FIG. 8 depicts a parallel processing unit in accordance with one embodiment.

FIG. 9 depicts a general processing cluster in accordance with one embodiment.

FIG. 10 depicts a memory partition unit in accordance with one embodiment.

FIG. 11 depicts a streaming multiprocessor in accordance with one embodiment.

FIG. 12 depicts a processing system in accordance with one embodiment.

FIG. 13 depicts an exemplary processing system in accordance with another embodiment.

### DETAILED DESCRIPTION

Disclosed herein are embodiments of a visual language processor configured for region-level reasoning and description. The visual language processor enables region-level captioning, reasoning, classification, and expression comprehension by a multimodal large language model. Inputs referencing regions of interest of any shape are transformed with semantic region-level embeddings that are applied to a language encoder.

The disclosed visual language processors enable complex region-level captioning and understanding. Embodiments of these processors are described that enhance the spatial awareness of regional representation with efficient yet effective modifications to conventional image encoders.

The performance of the disclosed visual language processors may be enhanced by constraining a specific output scope with integrated task-guided instruction prompts during both training and inference. These prompts may be integrated while maintaining the processor's versatility for more general-purpose (non-region specific) tasks.

Also disclosed are implementations comprising an automated region caption data generation pipeline for enriching the training sets utilized to configure the visual language processor with detailed region-level captions.

The disclosed mechanisms may perform a refining transformation on visual features extracted by a system such as CLIP with mask pooling to support defining regions of interest (Rol) of any shape. These features may significantly enhance the language model performance over conventional models on understanding of spatial-aware semantic concepts.

The Contrastive Language-Image Pre-training (CLIP) model developed by OpenAI may be utilized to extract meaningful representations from images. The extractor uses a neural network, for example a variant of a Vision Transformer (ViT) or ResNet architecture, to encode visual information into a feature space. This feature space is then aligned with textual embeddings derived from a text encoder, enabling the CLIP model to perform various tasks such as image recognition and zero-shot learning. The CLIP model may associate images and text without the need for task-specific training, leveraging a large dataset of image-text pairs to achieve this capability.

The disclosed mechanisms may utilize prompts with integrated vision tasks. Examples are closed-set classification and referring-expression comprehension. Conventional region-level captioning datasets utilized to train VLMs may provide overly-simplistic descriptions of regions that lack detailed attributes such as color, shape, style and spatial relations with the surroundings. An automated pipeline for annotating detailed region-level captions may be utilized to alleviate manual labelling. The automated pipeline may be implemented by reconfiguring an existing object detection dataset utilizing a two-stage GPT-assisted approach.

The disclosed artificial intelligence models may be configured to provide complex region-level object captioning in images, as well as the reasoning, classification, and expression comprehension capabilities of a multi-modal large language model. Users may input prompts to the model specifying regions of interest in an image of any shape. The prompts may comprise a placeholder, e.g., “<region>” at any position. A visual-language connector of the model replaces the placeholder with semantic region-level embeddings that are then processed through a language encoder.

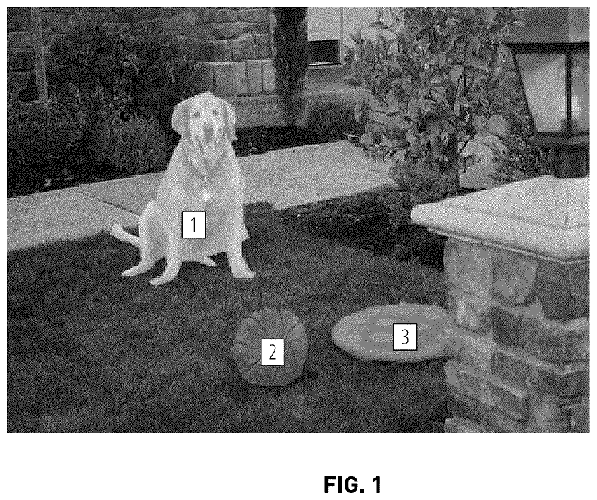

The image in FIG. 1 comprises a dog depicted in a first region (region 1), a basketball depicted in a second region (region 2), and a frisbee toy in a third region (region 3).

An example of region-level reasoning task that the disclosed models may carry out on this image is:
Prompt: How do I keep <region 1>engaged in playtime?
Model Response: It is a dog. To keep the dog engaged in playtime, it is essential to provide a variety of toys and activities. In the image, the dog is sitting on the grass next to a basketball and a frisbee. These toys can be used for fetching, catching, and throwing which are all enjoyable activities for dogs. Additionally, incorporating different types of toys, such as balls, ropes, and tug toys, can help keep the dog mentally and physically stimulated. Regular playtime sessions, including walks, jogs, and interactive games, can also help keep the dog engaged and happy.

An example of region-level description task that the disclosed models may carry out on this image is:
Prompt: Describe in detail the object located at <region2> in the image.
Response: The basketball in the image is orange and appears to be a standard-sized basketball used for playing basketball games. It is placed on the grass, likely for the dog to play with or for the owner to use during a game. The basketball is likely made of rubber with a leather or synthetic cover. In the close-up view, the basketball appears to be deflated or not fully inflated.

An example of an expression comprehension task that the disclosed models may carry out on this image is:

Prompt: From the provided masks denoted by <region1>, <region2>, and <region3>, which one represents the sport that Michael Jordan is best at?

Response: Basketball. Region [2].

An example of an object classification task that the disclosed models may carry out on this image is:

Prompt: What is the class name of <region3>?

Response: It is a frisbee.

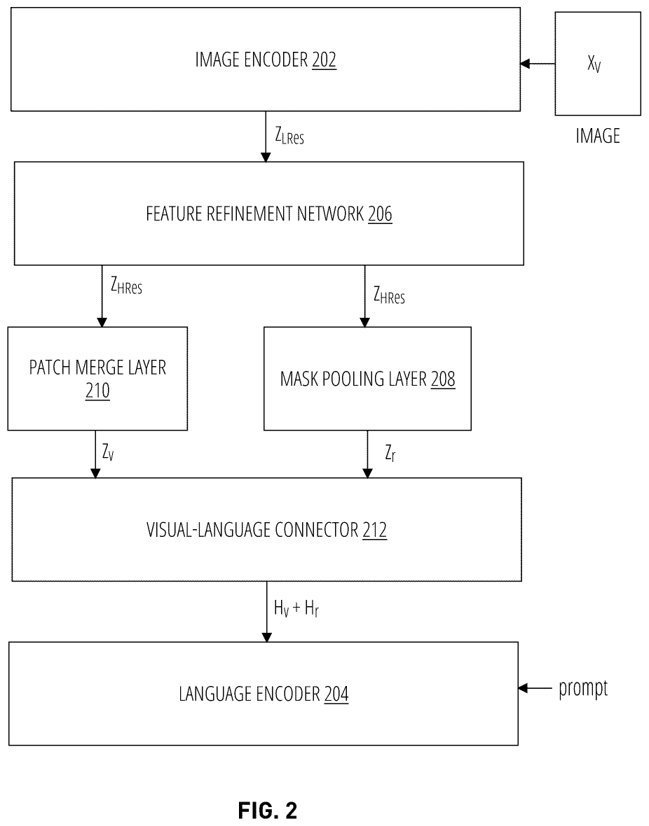

FIG. 2 depicts a visual language processor in one embodiment. The visual language processor comprises an image encoder 202 and a language encoder 204, a feature refinement network 206, one or more mask pooling layers 208, one or more patch merge layers 210, and a visual-language connector 212.

The the image encoder 202 is configured (trained) to transform an input image Xᵥ into a low-resolution map of semantic features Z_{LRes}. A feature refinement network 206 upsamples the low-resolution feature map Z_{LRes} into a higher-resolution feature map Z_{HRes}. The patch merge layers 210 extract image-level features Zᵥ from the high-resolution feature map Z_{HRes} and the mask pooling layers 208 extract region-level features Zᵣ of the image from the high-resolution feature map Z_{HRes}.

The visual-language connector 212 may comprise a multi-layer perceptron configured to project the image-level features Zᵥ and the region-level features Zᵣ of the image into text embeddings Hᵥ and Hᵣ, respectively, and these are merged with embeddings for a text prompt in a language encoder 204 (e.g., a Large Language Model).

The image encoder 202 may comprise a pretrained image feature extractor, e.g., a CLIP ViT-L model. CLIP-ViTL refers to a variant of CLIP comprising more layers and parameters than the base CLIP model, providing an enhanced image-to-semantics transformer capability.

A feature map of an image comprises a two-dimensional grid of features extracted from the image, e.g., by one or more convolutional layers in a neural network. Each element in the feature map corresponds to a particular feature detected at a specific location in the input image. An input image Xᵥ may be encoded into a low-resolution feature map by the image encoder 202. This process may be represented as Z_{LRes}=f(Xᵥ).

The feature refinement network 206 upscales the low-resolution feature map Z_{LRes} generated by the image encoder 202 utilizing, for example, a pair of transpose convolution layers.

A patch of an image feature map refers to a (typically) small, localized region or subsection of the feature map. Analyzing patches enables localized understanding and/or manipulation of the spatially distributed features generated (typically) by a convolutional network. The patch size of the low-resolution feature map Z_{LRes} generated by the image encoder 202 may comprise a resolution that is too low to represent small-scale regions and objects in the image. The feature refinement network 206 may in one embodiment comprise two deconvolution layers each configured with a stride of 2, that together upscale the input low-resolution feature map Z_{LRes} by a factor of four into a higher-resolution feature map Z_{HRes}. The feature refinement process g may be represented as Z_{HRes}=g(Z_{LRes}).

Mask pooling involves applying a spatial mask to a feature map to select areas of the image to select for pooling. This mask effectively highlights certain features in the feature map while ignoring others. Mask pooling may help preserve spatial structure within each region of interest in the image, enabling the model to make more accurate predictions about each detected object or instance. The mask ensures that only pertinent areas contribute to the pooled feature map, improving the performance of the model on localized tasks. Mask pooling may be applied to extract region-level features Zᵣ from the high-resolution feature map Z_{HRes}. The mask pooling may involve averaging the features of Z_{HRes} in regions Xᵣ to obtain the region-level features Zᵣ.

The generation of region-level features Zᵣ from regions Xᵣ of the high-resolution feature map Z_{HRes}, using mask pooling MaskPool, may be represented as Zᵣ=MaskPool (Z_{HRes}, Xᵣ).

Adaptive pooling in a neural network refers to a pooling layer that outputs a fixed-size tensor, irrespective of the input dimensions. Unlike non-adaptive pooling mechanisms that comprise fixed kernel sizes and strides, adaptive pooling may adjust these parameters for different inputs to ensure a specific output tensor size.

Adaptive pooling may be utilized to process inputs of varying dimensions without requiring resizing operations, making it applicable to models that process inputs of variable sizes. Adaptive pooling mechanisms may calculate the pooling window (kernel) and stride dynamically to achieve the target output size, preserving structural information of the input while standardizing the feature dimensions for subsequent layers.

Training and inference may be slowed down and use a greater amount of energy when utilizing higher-resolution feature maps. To mitigate this effect, an adaptive pooling layer AdaPool may be applied to merge patches of image-level features in the high-resolution feature map Z_{HRes}. This process may be represented as Zᵥ=AdaPool (Z_{HRes}, (H, W)), where (H, W) is the dimensions of the resulting feature map Zᵥ of image-level features.

The visual-language connector 212 associates the visual features of the image with semantic features. The visual-language connector 212 may align visual features extracted from images with textual semantic features learned from language training, enabling the model to associate corresponding elements across both modalities. By linking visual and language modalities, the visual-language connector 212 may enhance the visual language processor's ability to perform tasks such as image captioning, answering questions about visual elements, and performing cross-modal information retrieval. The visual-language connector 212 may project both visual and textual features into a shared embedding space of the language encoder 204, enabling the visual language processor to compare and relate visual and textual elements.

A dataset with image-caption pairs may be utilized to train the visual-language connector 212, employing contrastive loss, cross-entropy loss, or similar mechanisms to align the visual and textual modalities.

In one embodiment, a multilayer (e.g., two-layer) perceptron may be utilized as a visual-language connector 212 to project visual features from the patch merge layers 210 and from the mask pooling layers 208 into the embedding space of the language encoder 204. The image-level features Zᵥ and the region-level image features Zᵣ may both be processed through the same visual-language connector 212 to maintain semantic consistency.

The language encoder 204 is configured (trained) to tokenize and transform text inputs into word embeddings. The image-level features Zᵥ and the region-level image features Zᵣ are input into the embedding space of the language encoder 204 along with the embedding of the text input prompt.

To train the visual language processor, multiple prompts may be generated for each input image Xᵥ, where T is the number of prompt/response iterations, X_{q}^{t} is the t-th instruction (prompt) and Xₐ^{t} is the corresponding response. The image Xᵥ may be used to provide the visual language processor with context for the prompts.

To facilitate region-level responses, a special-purpose token “<region>” may be utilized as a placeholder in some of the prompts. The language encoder 204 of the visual language processor responses may replace this placeholder with the corresponding region embedding Hᵣ. The training loss may in one embodiment be configured to be an auto-regressive training objective. The target values for the visual language processor's learning function may be configured to be the desired responses.

The learning function quantifies the visual language processor's prediction error and adjusts the visual language processor's parameters to minimize the difference between its predictions (responses) and the correct responses. The learning function may for example determine a mean squared error or cross-entropy loss between predictions and correct responses. During training, optimization algorithms such as gradient descent may iteratively update the visual language processor's parameters to configure the values that minimize the loss function output, thereby improving the visual language processor's performance on the trained tasks.

The language encoder 204 utilized by the visual language processor may be trained without imposing restrictions on the range of its responses to enable functional flexibility and adaptability. However, certain tasks may call for specific output formats. For example, the visual language processor may be provided with a specified bounding box and tasked to output only the corresponding class name corresponding to contents of the bounding box. In this case the generated response may be selected from a predetermined set of candidate categories.

An example of this type of task is a so-called COCO (Common Objects in Context) detection challenge. The challenge involves correctly identifying where objects are located in an image (localization) and categorizing each object (classification). This is typically handled by predicting a bounding box around each object of interest in the image and assigning a class label to each bounding box from a predefined set of categories.

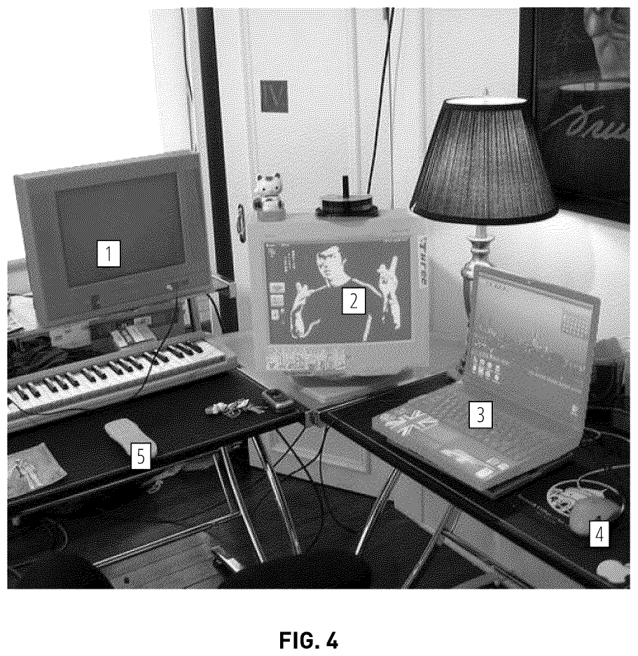

To train the language encoder 204 responses to specific tasks such as this, specialized instruction prompts (input symbol sequences) may be engineered that guide the language encoder 204 to the desired output formats. Examples of such specialized instruction prompts are described in conjunction with FIG. 4. The task-guided instruction prompt facilitates versatility and accuracy in the language encoder 204 for task-specific applications

To maintain and enhance the visual language processor's capability to interpret images at both the global (image-wide) and regional levels, a joint training procedure may be utilized comprising both image-level (global) and region-level tasks.

A dataset utilized for global training may comprise pairs of images and text captions. To bolster the visual language processor's proficiency in interpreting and interacting with regional aspects of images, it may be jointly (with the global training set) be trained on datasets comprising images annotated with objects, attributes, and relationships to provide detailed scene understanding (e.g., Visual Genome). These datasets may be transformed into multi-turn conversational formats, which assists the model in region-based relationship understanding, captioning, and classification.

During training, weights for the image encoder 202 and the language encoder 204 may be held fixed while adapting weights of the feature refinement network 206 and the visual-language connector 212 to align the image features with language embeddings.

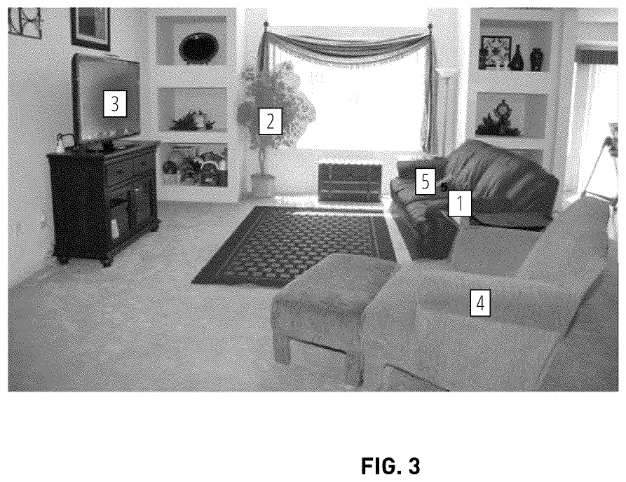

FIG. 3 depicts an exemplary scene comprising a a couch (region 1), a plant (region 2), a television screen (region 3), a chair (region 4), and an object lying on the couch (region 5).

An example of a region-level reasoning task that the disclosed visual language processor may carry out on this image is:

Prompt: Can you figure out when <region3> was made?

Response: Unfortunately, I cannot determine the exact age of the television in the image. However, it is a flat-screen TV, which suggests that it was likely made in the last few decades. Flat-screen TVs were first introduced in the 1990s and have since become the dominant form of television display.

An example of an expression comprehension task that the disclosed visual language processor may carry out on this image is:

Prompt: Given the proposals <region1>, <region2>, <region3>, <region4> and <region5>, can you pinpoint which one matches a dark colored couch?

Response: Region [1].

An example of complex region-level description task that the disclosed visual language processor may carry out on this image is:

Prompt: Describe in detail the object located at <region1> in the image.

Assistant: The couch in the image is a large, brown leather couch. It has a sleek and modem design, with a comfortable and inviting appearance. The couch is positioned in the living room, surrounded by other furniture such as a chair and a potted plant. The leather material gives the couch a luxurious and durable look, making it an ideal choice for a cozy and stylish living space.

An example of an object classification task that the disclosed visual language processor may carry out on this image is:

Prompt: What category name best describes the mask represented by <region2>?

Assistant: Potted plant.

FIG. 4 depicts an exemplary image and the use of task-guided instruction prompts to specify a response format from the visual language processor. In the examples below, the guiding portion of the prompt is shown in square brackets.

COCO Object Detection

Prompt: What category name best describes the region represented by (region1)? [Answer the question using COCO-80 category names.]

Response: TV

Prompt: How would you label the section <region3>?

Response: Laptop

Referring Expression Comprehension

Prompt: From the provided masks denoted by <region1>, <region2>, <region3>, <region4> and <region5>, which one fits “a desktop monitor with Bruce Lee photo on it”? [Answer the question using the template Region (x)].

Response: Region (2).

Prompt: Match the object with its description: a black Xbox 360.

Response: No corresponding options found.

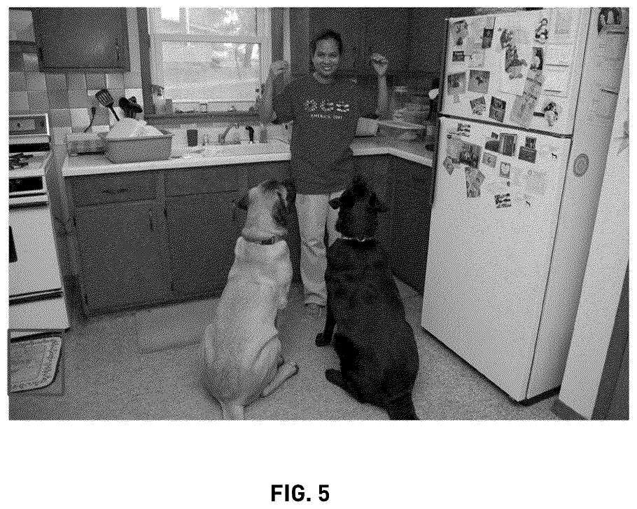

FIG. 5 depicts an exemplary image and a two-stage process by which the responses from the visual language processor may accurately describe a local region in terms of color, size and style. The accuracy of responses may be reduced when a global caption and/or class names are not provided during training, resulting in responses from the visual language processor that are vague or over-simplified, or a failure of the visual language processor to focus on the region of interest and instead repeating the global context in the response. In stage 2 the “close up” is the region of the image in the depicted bounding box in the left-hand lower corner.

### Stage 1

Prompt: Describe the image in detail.

Response: The image features a man standing in a kitchen, surrounded by two large dogs. The man appears to be feeding the dogs, as they eagerly wait for their treats. The kitchen is well-equipped with a refrigerator, an oven, and a sink. Various items can be seen on the countertops, such as a cup, a bowl, and a spoon. There are also two bottles placed in the kitchen, one near the sink and the other closer to the refrigerator. The scene captures a moment of bonding between the man and his dogs in a cozy home setting.

### Stage 2

Prompt: In the context of the entire image, <GlobalCaption>. Can you describe the <ClassName> in this close-up? Highlight its color, appearance, size, style, and any unique features. Assistant: The carpet in the close-up region is brown and has a rectangular shape. It appears to be made of soft, textured material, possibly a woven or knitted fabric. The style of the carpet suggests a traditional or classic design, which complements the overall aesthetic of the kitchen.

The following prompt/response are for a version of the visual language processor trained on images lacking the global captions and class names:

Prompt: Can you describe the close-up region in detail?

Response: The image features a close-up view of a decorative item, possibly a plaque or a piece of artwork, with Arabic writing on it. The writing appears to be in a foreign language, and the item is placed on a surface, possibly a table or a floor. The focus of the image is on the intricate details of the writing and the overall design of the decorative item.

The following prompt/response are for a version of the visual language processor trained on images lacking global captions:

User: Can you describe the close-up region in detail?

Assistant: The carpet in this image is brown and has a rug on top of it. The rug is decorated with a design and has a border around it.

The following prompt/response are for a version of the visual language processor trained on images lacking class names:

Prompt: In the context of the entire image, <GlobalCaption>. Can you describe the close-up region in detail?

Response: The close-up image features a man standing in a kitchen, surrounded by two large dogs. The man appears to be feeding the dogs, as they eagerly wait for their treats. The kitchen is well-equipped with a refrigerator, an oven, and a sink. Various items can be seen on the countertops, such as a cup, a bowl, and a spoon. There are also two bottles placed in the kitchen, one near the sink and the other closer to the refrigerator. The scene captures a moment of bonding between the man and his dog in a cozy home setting.

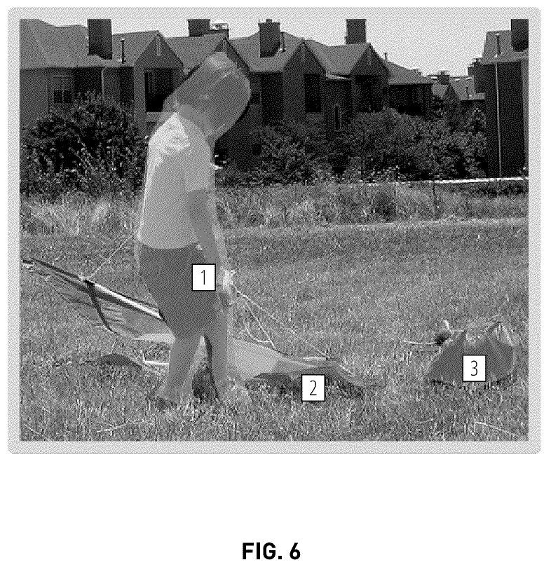

FIG. 6 depicts an exemplary image and the example below demonstrates the visual language processor's reasoning capability and ability to describe relationships between different regions within the image in a multi-turn conversation.

Prompt: What is present in <region2>?

Response: The kite in the image is red, yellow, and blue.

Prompt: Describe the relationship between <region1> and <region2>.

Response: The little girl is holding the kite and preparing to fly it.

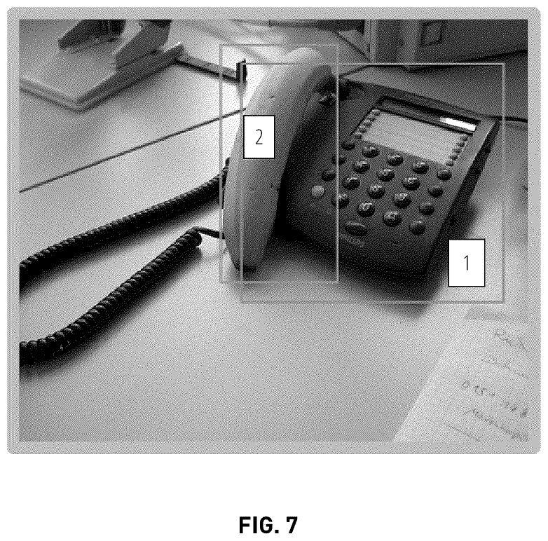

FIG. 7 depicts an exemplary image and the example below demonstrates the visual language processor's reasoning capability and ability to describe relationships between different regions within the image.

Prompt: Why is <region1> put on <region2>?

Response: The banana is placed on the phone to create a humorous and unexpected scene. It is not a typical use for a banana, as it is not a communication device. The banana's placement on the phone might be a playful act or a prank, intending to evoke amusement or surprise from the viewer. This unusual combination of objects can be seen as a light-hearted and creative way to break away from the ordinary and make people smile or think about the scene.

The visual language processors disclosed herein may be implemented in and/or trained using computing devices utilizing one or more graphic processing unit (GPU) and/or general purpose data processor (e.g., a ‘central processing unit or CPU). Exemplary architectures will now be described that may be configured to implement the visual language processors disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

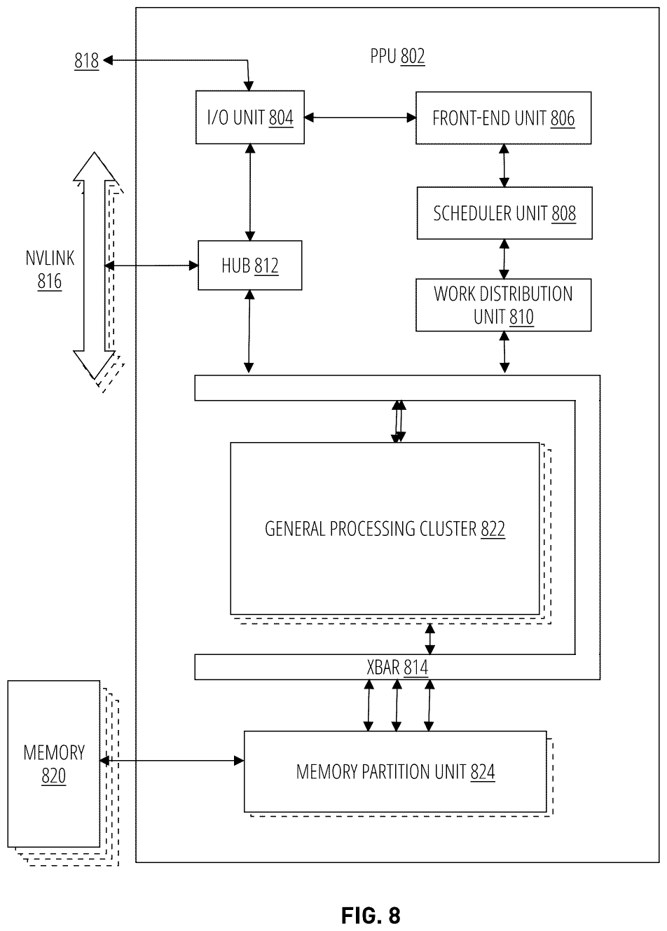

FIG. 8 depicts a parallel processing unit 802, in accordance with an embodiment. In an embodiment, the parallel processing unit 802 is a multi-threaded processor that is implemented on one or more integrated circuit devices. The parallel processing unit 802 is a latency hiding architecture designed to process many threads in parallel. A thread (e.g., a thread of execution) is an instantiation of a set of instructions configured to be executed by the parallel processing unit 802. In an embodiment, the parallel processing unit 802 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 802 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 802 modules may be configured to accelerate thousands of High Performance Computing (HPC), data center, and machine learning applications. The parallel processing unit 802 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 8, the parallel processing unit 802 includes an I/O unit 804, a front-end unit 806, a scheduler unit 808, a work distribution unit 810, a hub 812, a crossbar 814, one or more general processing cluster 822 modules, and one or more memory partition unit 824 modules. The parallel processing unit 802 may be connected to a host processor or other parallel processing unit 802 modules via one or more high-speed NVLink 816 interconnects. The parallel processing unit 802 may be connected to a host processor or other peripheral devices via an interconnect 818. The parallel processing unit 802 may also be connected to a local memory comprising a number of memory 820 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 820 may comprise logic to configure the parallel processing unit 802 to carry out aspects of the techniques disclosed herein. The memory 820 may be configured with machine instructions that configure a computer system or device to implement a visual language processor in accordance with the disclosed embodiments.

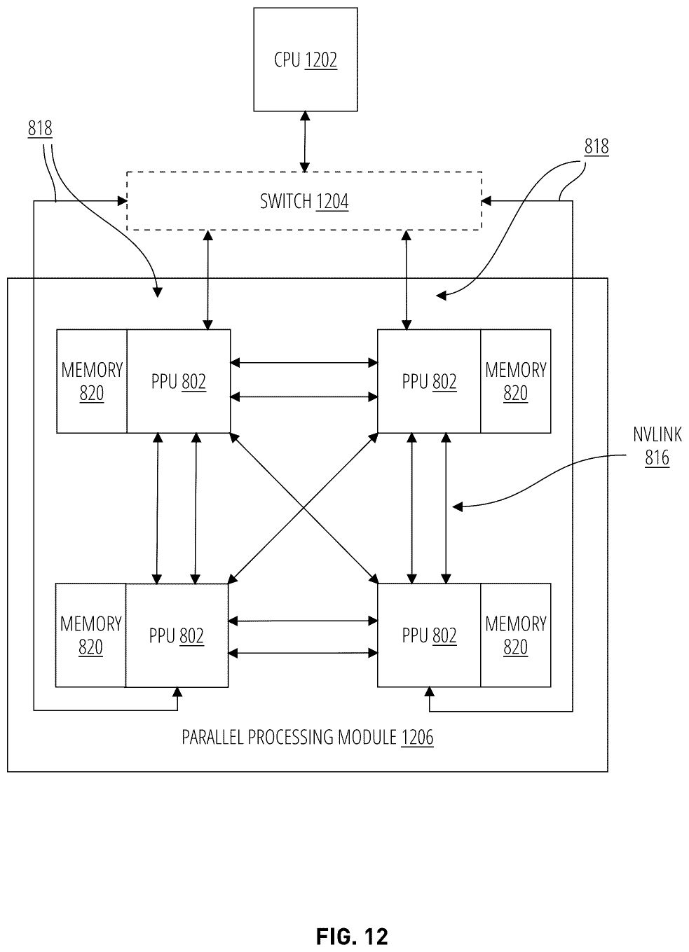

The NVLink 816 interconnect enables systems to scale and include one or more parallel processing unit 802 modules combined with one or more CPUs, supports cache coherence between the parallel processing unit 802 modules and CPUs, and CPU mastering. Data and/or commands may be transmitted by the NVLink 816 through the hub 812 to/from other units of the parallel processing unit 802 such as one or more copy engines, a video encoder, a video decoder, a power management unit, etc. (not explicitly shown). The NVLink 816 is described in more detail in conjunction with FIG. 12.

The I/O unit 804 is configured to transmit and receive communications (e.g., commands, data, etc.) from a host processor (not shown) over the interconnect 818. The I/O unit 804 may communicate with the host processor directly via the interconnect 818 or through one or more intermediate devices such as a memory bridge. In an embodiment, the I/O unit 804 may communicate with one or more other processors, such as one or more parallel processing unit 802 modules via the interconnect 818. In an embodiment, the I/O unit 804 implements a Peripheral Component Interconnect Express (PCIe) interface for communications over a PCIe bus and the interconnect 818 is a PCIe bus. In alternative embodiments, the I/O unit 804 may implement other types of well-known interfaces for communicating with external devices.

The I/O unit 804 decodes packets received via the interconnect 818. In an embodiment, the packets represent commands configured to cause the parallel processing unit 802 to perform various operations. The I/O unit 804 transmits the decoded commands to various other units of the parallel processing unit 802 as the commands may specify. For example, some commands may be transmitted to the front-end unit 806. Other commands may be transmitted to the hub 812 or other units of the parallel processing unit 802 such as one or more copy engines, a video encoder, a video decoder, a power management unit, etc. (not explicitly shown). In other words, the I/O unit 804 is configured to route communications between and among the various logical units of the parallel processing unit 802.

In an embodiment, a program executed by the host processor encodes a command stream in a buffer that provides workloads to the parallel processing unit 802 for processing. A workload such as training of or inference by a visual language processor may comprise several instructions and data to be processed by those instructions. The buffer is a region in a memory that is accessible (e.g., read/write) by both the host processor and the parallel processing unit 802. For example, the I/O unit 804 may be configured to access the buffer in a system memory connected to the interconnect 818 via memory requests transmitted over the interconnect 818. In an embodiment, the host processor writes the command stream to the buffer and then transmits a pointer to the start of the command stream to the parallel processing unit 802. The front-end unit 806 receives pointers to one or more command streams. The front-end unit 806 manages the one or more streams, reading commands from the streams and forwarding commands to the various units of the parallel processing unit 802.

The front-end unit 806 is coupled to a scheduler unit 808 that configures the various general processing cluster 822 modules to process tasks defined by the one or more streams. The scheduler unit 808 is configured to track state information related to the various tasks managed by the scheduler unit 808. The state may indicate which general processing cluster 822 a task is assigned to, whether the task is active or inactive, a priority level associated with the task, and so forth. The scheduler unit 808 manages the execution of a plurality of tasks on the one or more general processing cluster 822 modules.

The scheduler unit 808 is coupled to a work distribution unit 810 that is configured to dispatch tasks for execution on the general processing cluster 822 modules. The work distribution unit 810 may track a number of scheduled tasks received from the scheduler unit 808. In an embodiment, the work distribution unit 810 manages a pending task pool and an active task pool for each of the general processing cluster 822 modules. The pending task pool may comprise a number of slots (e.g., 32 slots) that contain tasks assigned to be processed by a particular general processing cluster 822. The active task pool may comprise a number of slots (e.g., 4 slots) for tasks that are actively being processed by the general processing cluster 822 modules. As a general processing cluster 822 finishes the execution of a task, that task is evicted from the active task pool for the general processing cluster 822 and one of the other tasks from the pending task pool is selected and scheduled for execution on the general processing cluster 822. If an active task has been idle on the general processing cluster 822, such as while waiting for a data dependency to be resolved, then the active task may be evicted from the general processing cluster 822 and returned to the pending task pool while another task in the pending task pool is selected and scheduled for execution on the general processing cluster 822.

The work distribution unit 810 communicates with the one or more general processing cluster 822 modules via crossbar 814. The crossbar 814 is an interconnect network that couples many of the units of the parallel processing unit 802 to other units of the parallel processing unit 802. For example, the crossbar 814 may be configured to couple the work distribution unit 810 to a particular general processing cluster 822. Although not shown explicitly, one or more other units of the parallel processing unit 802 may also be connected to the crossbar 814 via the hub 812.

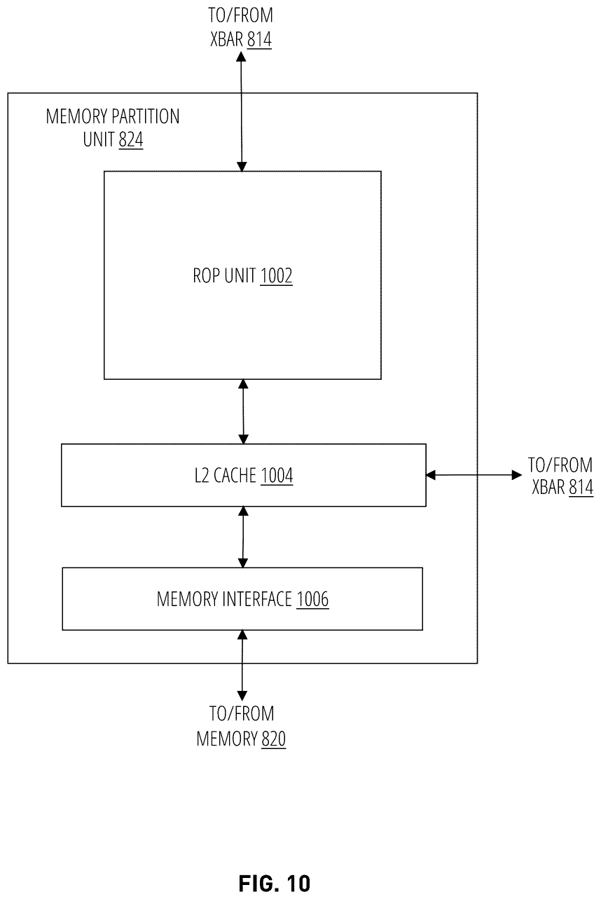

The tasks are managed by the scheduler unit 808 and dispatched to a general processing cluster 822 by the work distribution unit 810. The general processing cluster 822 is configured to process the task and generate results. The results may be consumed by other tasks within the general processing cluster 822, routed to a different general processing cluster 822 via the crossbar 814, or stored in the memory 820. The results can be written to the memory 820 via the memory partition unit 824 modules, which implement a memory interface for reading and writing data to/from the memory 820. The results can be transmitted to another parallel processing unit 802 or CPU via the NVLink 816. In an embodiment, the parallel processing unit 802 includes a number U of memory partition unit 824 modules that is equal to the number of separate and distinct memory 820 devices coupled to the parallel processing unit 802. A memory partition unit 824 will be described in more detail below in conjunction with FIG. 10.

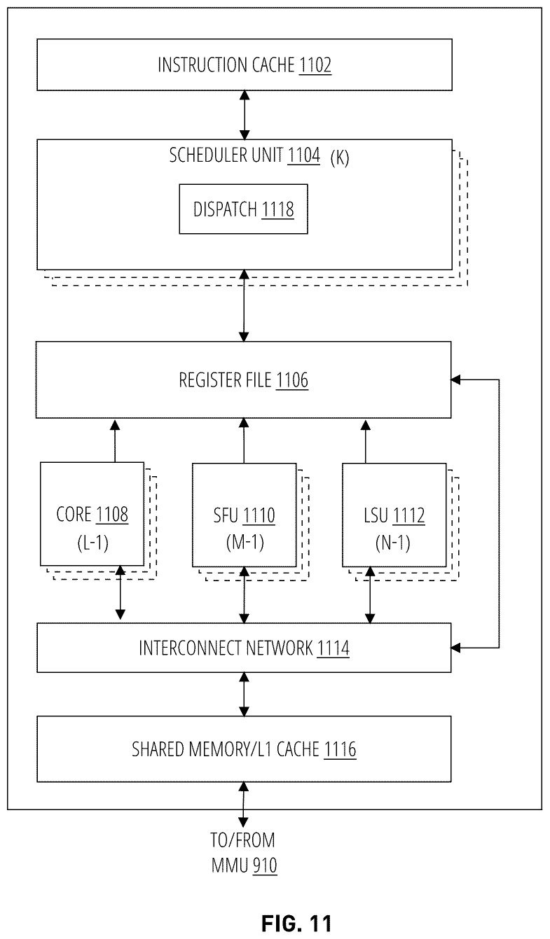

In an embodiment, a host processor executes a driver kernel that implements an application programming interface (API) that enables one or more applications executing on the host processor to schedule operations for execution on the parallel processing unit 802. In an embodiment, multiple compute applications are simultaneously executed by the parallel processing unit 802 and the parallel processing unit 802 provides isolation, quality of service (QoS), and independent address spaces for the multiple compute applications. An application or portions thereof, such as a visual language processor or a layer of a visual language processor, may generate instructions (e.g., API calls) that cause the driver kernel to generate one or more tasks for execution by the parallel processing unit 802. The driver kernel outputs tasks to one or more streams being processed by the parallel processing unit 802. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 11.

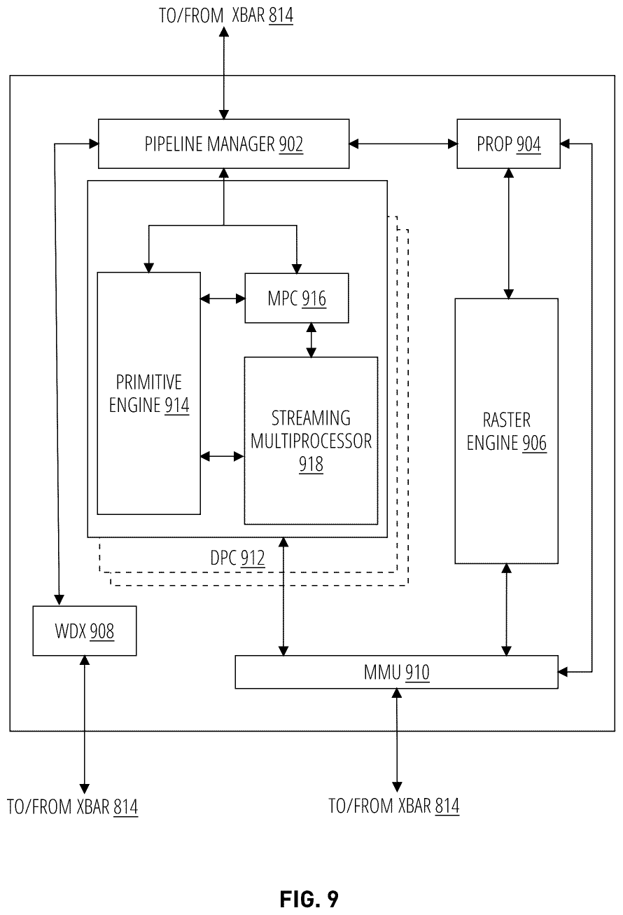

FIG. 9 depicts a general processing cluster 822 of the parallel processing unit 802 of FIG. 8, in accordance with an embodiment. As shown in FIG. 9, each general processing cluster 822 includes a number of hardware units for processing tasks. In an embodiment, each general processing cluster 822 includes a pipeline manager 902, a pre-raster operations unit 904, a raster engine 906, a work distribution crossbar 908, a memory management unit 910, and one or more data processing cluster 912. It will be appreciated that the general processing cluster 822 of FIG. 9 may include other hardware units in lieu of or in addition to the units shown in FIG. 9.

In an embodiment, the operation of the general processing cluster 822 is controlled by the pipeline manager 902. The pipeline manager 902 manages the configuration of the one or more data processing cluster 912 modules for processing tasks allocated to the general processing cluster 822. In an embodiment, the pipeline manager 902 may configure at least one of the one or more data processing cluster 912 modules to implement at least a portion of a graphics rendering pipeline. For example, a data processing cluster 912 may be configured to execute a vertex shader program on the programmable streaming multiprocessor 918. The pipeline manager 902 may also be configured to route packets received from the work distribution unit 810 to the appropriate logical units within the general processing cluster 822. For example, some packets may be routed to fixed function hardware units in the pre-raster operations unit 904 and/or raster engine 906 while other packets may be routed to the data processing cluster 912 modules for processing by the primitive engine 914 or the streaming multiprocessor 918. In an embodiment, the pipeline manager 902 may configure at least one of the one or more data processing cluster 912 modules to implement a neural network model and/or a computing pipeline.

The pre-raster operations unit 904 is configured to route data generated by the raster engine 906 and the data processing cluster 912 modules to a Raster Operations (ROP) unit, described in more detail in conjunction with FIG. 10. The pre-raster operations unit 904 may also be configured to perform optimizations for color blending, organize pixel data, perform address translations, and the like.

The raster engine 906 includes a number of fixed function hardware units configured to perform various raster operations. In an embodiment, the raster engine 906 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 906 comprises fragments to be processed, for example, by a fragment shader implemented within a data processing cluster 912.

Each data processing cluster 912 included in the general processing cluster 822 includes an M-pipe controller 916, a primitive engine 914, and one or more streaming multiprocessor 918 modules. The M-pipe controller 916 controls the operation of the data processing cluster 912, routing packets received from the pipeline manager 902 to the appropriate units in the data processing cluster 912. For example, packets associated with a vertex may be routed to the primitive engine 914, which is configured to fetch vertex attributes associated with the vertex from the memory 820. In contrast, packets associated with a shader program may be transmitted to the streaming multiprocessor 918.

The streaming multiprocessor 918 comprises a programmable streaming processor that is configured to process tasks represented by a number of threads. Each streaming multiprocessor 918 is multi-threaded and configured to execute a plurality of threads (e.g., 32 threads) from a particular group of threads concurrently. In an embodiment, the streaming multiprocessor 918 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 918 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 918 will be described in more detail below in conjunction with FIG. 11.

The memory management unit 910 provides an interface between the general

processing cluster 822 and the memory partition unit 824. The memory management unit 910 may provide translation of virtual addresses into physical addresses, memory protection, and arbitration of memory requests. In an embodiment, the memory management unit 910 provides one or more translation lookaside buffers (TLBs) for performing translation of virtual addresses into physical addresses in the memory 820.

FIG. 10 depicts a memory partition unit 824 of the parallel processing unit 802 of FIG. 8, in accordance with an embodiment. As shown in FIG. 10, the memory partition unit 824 includes a raster operations unit 1002, a level two cache 1004, and a memory interface 1006. The memory interface 1006 is coupled to the memory 820. Memory interface 1006 may implement 32, 64, 128, 1024-bit data buses, or the like, for high-speed data transfer. In an embodiment, the parallel processing unit 802 incorporates U memory interface 1006 modules, one memory interface 1006 per pair of memory partition unit 824 modules, where each pair of memory partition unit 824 modules is connected to a corresponding memory 820 device. For example, parallel processing unit 802 may be connected to up to Y memory 820 devices, such as high bandwidth memory stacks or graphics double-data-rate, version 5, synchronous dynamic random access memory, or other types of persistent storage.

In an embodiment, the memory interface 1006 implements an HBM2 memory interface and Y equals half U. In an embodiment, the HBM2 memory stacks are located on the same physical package as the parallel processing unit 802, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 820 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 802 modules process very large datasets and/or run applications for extended periods.

In an embodiment, the parallel processing unit 802 implements a multi-level memory hierarchy. In an embodiment, the memory partition unit 824 supports a unified memory to provide a single unified virtual address space for CPU and parallel processing unit 802 memory, enabling data sharing between virtual memory systems. In an embodiment the frequency of accesses by a parallel processing unit 802 to memory located on other processors is traced to ensure that memory pages are moved to the physical memory of the parallel processing unit 802 that is accessing the pages more frequently. In an embodiment, the NVLink 816 supports address translation services allowing the parallel processing unit 802 to directly access a CPU's page tables and providing full access to CPU memory by the parallel processing unit 802.

In an embodiment, copy engines transfer data between multiple parallel processing unit 802 modules or between parallel processing unit 802 modules and CPUs. The copy engines can generate page faults for addresses that are not mapped into the page tables. The memory partition unit 824 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 820 or other system memory may be fetched by the memory partition unit 824 and stored in the level two cache 1004, which is located on-chip and is shared between the various general processing cluster 822 modules. As shown, each memory partition unit 824 includes a portion of the level two cache 1004 associated with a corresponding memory 820 device. Lower level caches may then be implemented in various units within the general processing cluster 822 modules. For example, each of the streaming multiprocessor 918 modules may implement an L1 cache. The L1 cache is private memory that is dedicated to a particular streaming multiprocessor 918. Data from the level two cache 1004 may be fetched and stored in each of the L1 caches for processing in the functional units of the streaming multiprocessor 918 modules. The level two cache 1004 is coupled to the memory interface 1006 and the crossbar 814.

The raster operations unit 1002 performs graphics raster operations related to pixel color, such as color compression, pixel blending, and the like. The raster operations unit 1002 also implements depth testing in conjunction with the raster engine 906, receiving a depth for a sample location associated with a pixel fragment from the culling engine of the raster engine 906. The depth is tested against a corresponding depth in a depth buffer for a sample location associated with the fragment. If the fragment passes the depth test for the sample location, then the raster operations unit 1002 updates the depth buffer and transmits a result of the depth test to the raster engine 906. It will be appreciated that the number of partition memory partition unit 824 modules may be different than the number of general processing cluster 822 modules and, therefore, each raster operations unit 1002 may be coupled to each of the general processing cluster 822 modules. The raster operations unit 1002 tracks packets received from the different general processing cluster 822 modules and determines which general processing cluster 1 that a result generated by the raster operations unit 1002 is routed to through the crossbar 814. Although the raster operations unit 1002 is included within the memory partition unit 824 in FIG. 10, in other embodiment, the raster operations unit 1002 may be outside of the memory partition unit 824. For example, the raster operations unit 1002 may reside in the general processing cluster 822 or another unit.

FIG. 11 illustrates the streaming multiprocessor 918 of FIG. 9, in accordance with an embodiment. As shown in FIG. 11, the streaming multiprocessor 918 includes an instruction cache 1102, one or more scheduler unit 1104 modules (e.g., such as scheduler unit 808), a register file 1106, one or more processing core 1108 modules, one or more special function unit 1110 modules, one or more load/store unit 1112 modules, an interconnect network 1114, and a shared memory/L1 cache 1116.

As described above, the work distribution unit 810 dispatches tasks for execution on the general processing cluster 822 modules of the parallel processing unit 802. The tasks are allocated to a particular data processing cluster 912 within a general processing cluster 822 and, if the task is associated with a shader program, the task may be allocated to a streaming multiprocessor 918. The scheduler unit 808 receives the tasks from the work distribution unit 810 and manages instruction scheduling for one or more thread blocks assigned to the streaming multiprocessor 918. The scheduler unit 1104 schedules thread blocks for execution as warps of parallel threads, where each thread block is allocated at least one warp. In an embodiment, each warp executes 32 threads. The scheduler unit 1104 may manage a plurality of different thread blocks, allocating the warps to the different thread blocks and then dispatching instructions from the plurality of different cooperative groups to the various functional units (e.g., core 1108 modules, special function unit 1110 modules, and load/store unit 1112 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1118 unit is configured within the scheduler unit 1104 to transmit instructions to one or more of the functional units. In one embodiment, the scheduler unit 1104 includes two dispatch 1118 units that enable two different instructions from the same warp to be dispatched during each clock cycle. In alternative embodiments, each scheduler unit 1104 may include a single dispatch 1118 unit or additional dispatch 1118 units.

Each streaming multiprocessor 918 includes a register file 1106 that provides a set of registers for the functional units of the streaming multiprocessor 918. In an embodiment, the register file 1106 is divided between each of the functional units such that each functional unit is allocated a dedicated portion of the register file 1106. In another embodiment, the register file 1106 is divided between the different warps being executed by the streaming multiprocessor 918. The register file 1106 provides temporary storage for operands connected to the data paths of the functional units.

Each streaming multiprocessor 918 comprises L processing core 1108 modules. In an embodiment, the streaming multiprocessor 918 includes a large number (e.g., 128, etc.) of distinct processing core 1108 modules. Each core 1108 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1108 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1108 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A ‘B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 918 also comprises M special function unit 1110 modules that perform special functions (e.g., attribute evaluation, reciprocal square root, and the like). In an embodiment, the special function unit 1110 modules may include a tree traversal unit configured to traverse a hierarchical tree data structure. In an embodiment, the special function unit 1110 modules may include texture unit configured to perform texture map filtering operations. In an embodiment, the texture units are configured to load texture maps (e.g., a 2D array of texels) from the memory 820 and sample the texture maps to produce sampled texture values for use in shader programs executed by the streaming multiprocessor 918. In an embodiment, the texture maps are stored in the shared memory/L1 cache 1116. The texture units implement texture operations such as filtering operations using mip-maps (e.g., texture maps of varying levels of detail). In an embodiment, each streaming multiprocessor 918 includes two texture units.

Each streaming multiprocessor 918 also comprises N load/store unit 1112 modules that implement load and store operations between the shared memory/L1 cache 1116 and the register file 1106. Each streaming multiprocessor 918 includes an interconnect network 1114 that connects each of the functional units to the register file 1106 and the load/store unit 1112 to the register file 1106 and shared memory/L1 cache 1116. In an embodiment, the interconnect network 1114 is a crossbar that can be configured to connect any of the functional units to any of the registers in the register file 1106 and connect the load/store unit 1112 modules to the register file 1106 and memory locations in shared memory/L1 cache 1116.

The shared memory/L1 cache 1116 is an array of on-chip memory that allows for data storage and communication between the streaming multiprocessor 918 and the primitive engine 914 and between threads in the streaming multiprocessor 918. In an embodiment, the shared memory/L1 cache 1116 comprises 128 KB of storage capacity and is in the path from the streaming multiprocessor 918 to the memory partition unit 824. The shared memory/L1 cache 1116 can be used to cache reads and writes. One or more of the shared memory/L1 cache 1116, level two cache 1004, and memory 820are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1116 enables the shared memory/L1 cache 1116 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 8, are bypassed, creating a much simpler programming model. In the general purpose parallel computation configuration, the work distribution unit 810 assigns and distributes blocks of threads directly to the data processing cluster 912 modules. The threads in a block execute the same program, using a unique thread ID in the calculation to ensure each thread generates unique results, using the streaming multiprocessor 918 to execute the program and perform calculations, shared memory/L1 cache 1116 to communicate between threads, and the load/store unit 1112 to read and write global memory through the shared memory/L1 cache 1116 and the memory partition unit 824. When configured for general purpose parallel computation, the streaming multiprocessor 918 can also write commands that the scheduler unit 808 can use to launch new work on the data processing cluster 912 modules.

The parallel processing unit 802 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 802 is embodied on a single semiconductor substrate. In another embodiment, the parallel processing unit 802 is included in a system-on-a-chip (SoC) along with one or more other devices such as additional parallel processing unit 802 modules, the memory 820, a reduced instruction set computer (RISC) CPU, a memory management unit (MMU), a digital-to-analog converter (DAC), and the like.

In an embodiment, the parallel processing unit 802 may be included on a graphics card that includes one or more memory devices. The graphics card may be configured to interface with a PCIe slot on a motherboard of a desktop computer. In yet another embodiment, the parallel processing unit 802 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 12 is a conceptual diagram of a processing system implemented using the parallel processing unit 802 of FIG. 8, in accordance with an embodiment. The processing system includes a central processing unit 1202, an switch 1204, and multiple parallel processing unit 802 modules each and respective memory 820 modules. The switch 1204 is depicted with dashed lines, indicating that it is optional in some embodiments.

The NVLink 816 provides high-speed communication links between each of the parallel processing unit 802 modules. Although a particular number of NVLink 816 and interconnect 818 connections are illustrated in FIG. 12, the number of connections to each parallel processing unit 802 and the central processing unit 1202 may vary. The switch 1204 interfaces between the interconnect 818 and the central processing unit 1202. The parallel processing unit 802 modules, memory 820 modules, and NVLink 816 connections may be situated on a single semiconductor platform to form a parallel processing module 1206. In an embodiment, the switch 1204 supports two or more protocols to interface between various different connections and/or links.

In another embodiment (not shown), the NVLink 816 provides one or more high-speed communication links between each of the parallel processing unit modules (parallel processing unit 802, parallel processing unit 802, parallel processing unit 802, and parallel processing unit 802) and the central processing unit 1202 and the switch 1204 (when present) interfaces between the interconnect 818 and each of the parallel processing unit modules. The parallel processing unit modules, memory 820 modules, and interconnect 818 may be situated on a single semiconductor platform to form a parallel processing module 1206. In yet another embodiment (not shown), the interconnect 818 provides one or more communication links between each of the parallel processing unit modules and the central processing unit 1202 and the switch 1204 interfaces between each of the parallel processing unit modules using the NVLink 816 to provide one or more high-speed communication links between the parallel processing unit modules. In another embodiment (not shown), the NVLink 816 provides one or more high-speed communication links between the parallel processing unit modules and the central processing unit 1202 through the switch 1204. In yet another embodiment (not shown), the interconnect 818 provides one or more communication links between each of the parallel processing unit modules directly. One or more of the NVLink 816 high-speed communication links may be implemented as a physical NVLink interconnect or either an on-chip or on-die interconnect using the same protocol as the NVLink 816.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1206 may be implemented as a circuit board substrate and each of the parallel processing unit modules and/or memory 820 modules may be packaged devices. In an embodiment, the central processing unit 1202, switch 1204, and the parallel processing module 1206 are situated on a single semiconductor platform.

In an embodiment, each parallel processing unit module includes six NVLink 816 interfaces (as shown in FIG. 12, five NVLink 816 interfaces are included for each parallel processing unit module). The NVLink 816 may be operated exclusively for PPU-to-PPU communication as shown in FIG. 12, or some combination of PPU-to-PPU and PPU-to-CPU, when the central processing unit 1202 also includes one or more NVLink 816 interfaces.

In an embodiment, the NVLink 816 allows direct load/store/atomic access from the central processing unit 1202 to each parallel processing unit module's memory 820. In an embodiment, the NVLink 816 supports coherency operations, allowing data read from the memory 820 modules to be stored in the cache hierarchy of the central processing unit 1202, reducing cache access latency for the central processing unit 1202. In an embodiment, the NVLink 816 includes support for Address Translation Services (ATS), enabling the parallel processing unit module to directly access page tables within the central processing unit 1202. One or more of the NVLink 816 may also be configured to operate in a low-power mode.

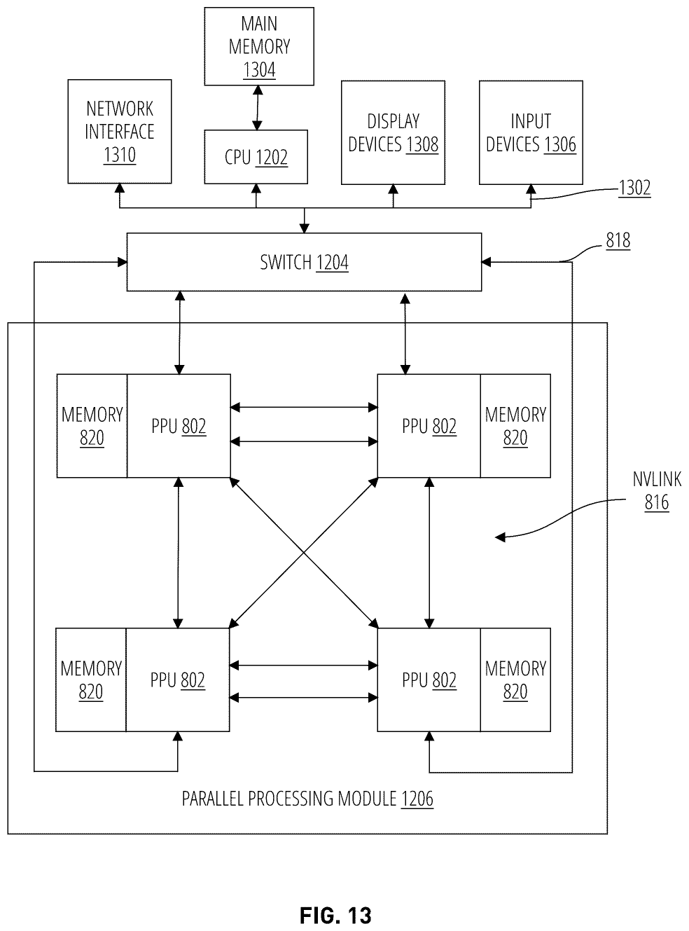

FIG. 13 depicts an exemplary processing system in which the various architecture and/or functionality of the various previous embodiments may be implemented. As shown, an exemplary processing system is provided including at least one central processing unit 1202 that is connected to a communications bus 1302. The communication communications bus 1302 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1304. Control logic (software) and data are stored in the main memory 1304 which may take the form of random access memory (RAM).

The exemplary processing system also includes input devices 1306, the parallel processing module 1206, and display devices 1308, e.g. a conventional CRT (cathode ray tube), LCD (liquid crystal display), LED (light emitting diode), plasma display or the like. User input may be received from the input devices 1306, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1310 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1304 and/or the secondary storage. Such computer programs, when executed, enable the exemplary processing system to perform various functions. The main memory 1304, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

202 image encoder
204 language encoder
206 feature refinement network
208 mask pooling layer
210 patch merge layer
212 visual-language connector
214 image
216 feature map
218 image region
802 parallel processing unit
804 I/O unit
806 front-end unit
808 scheduler unit
810 work distribution unit
812 hub
814 crossbar
816 NVLink
818 interconnect
820 memory
822 general processing cluster
824 memory partition unit
902 pipeline manager
904 pre-raster operations unit
906 raster engine
908 work distribution crossbar
910 memory management unit
912 data processing cluster
914 primitive engine
916 M-pipe controller
918 streaming multiprocessor
1002 raster operations unit
1004 level two cache
1006 memory interface
1102 instruction cache
1104 scheduler unit
1106 register file
1108 core
1110 special function unit
1112 load/store unit
1114 interconnect network
1116 shared memory/L1 cache
1118 dispatch
1202 central processing unit
1204 switch
1206 parallel processing module
1302 communications bus
1304 main memory
1306 input devices
1308 display devices
1310 network interface
1402 output data
1404 data assembly
1406 vertex shading
1408 primitive assembly
1410 geometry shading
1412 viewport SCC
1414 rasterization
1416 fragment shading
1418 raster operations
1420 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, clement B, and/or element C” may include only element A, only element B, only element C, clement A and element B, clement A and element C, clement B and clement C, or elements A, B, and C. In addition, “at least one of element A or element B” may include at least one of clement A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A visual language processor comprising:
an image encoder configured to convert an image into a low-resolution feature map;
a feature refinement network configured to upsample the low-resolution feature map into a high-resolution feature map;
a patch merge layer configured to transform the high-resolution feature map into an image-level feature map;
a mask pooling layer configured to transform the high-resolution feature map into a region-level feature map for the image; and
a visual-language connector configured to map the image-level feature map and the region-level feature map into an embedding space of a language encoder.

2. The visual language processor of claim 1, wherein the image encoder is configured by training on images, global captions for the images, and class labels for objects depicted in the images.

3. The visual language processor of claim 1, wherein the feature refinement network comprises a pair of deconvolution layers.

4. The visual language processor of claim 1, wherein the visual-language connector comprises a two layer perceptron network.

5. The visual language processor of claim 1, wherein the patch merge layer is configured with adaptive pooling.

6. The visual language processor of claim 1, wherein the language encoder comprises a large language model.

7. The visual language processor of claim 1, wherein the language encoder is trained with prompts comprising a special-purpose image region token.

8. The visual language processor of claim 7, wherein the language encoder is configured to replace the image region token with a corresponding image region embedding.

9. The visual language processor of claim 1, further configured with a learning function comprising an auto-regressive training objective.

10. A visual language processor comprising:
an image encoder configured by training on captioned images to convert images into low-resolution feature maps; and
a visual-language connector configured by training on image object class names to map an image-level feature map and a region-level feature map, both derived from an upsampled version of the low-resolution feature map, into an embedding space of a language encoder.

11. The visual language processor of claim 10, wherein the image encoder is configured by training on images, global captions for the images, and class labels for objects depicted in the images.

12. The visual language processor of claim 10, further comprising a feature refinement network configured to generate the upsampled version of the low-resolution feature map.

13. The further of claim 12, the feature refinement network comprising comprises a plurality of deconvolution layers.

14. The visual language processor of claim 10, wherein the visual-language connector comprises a multi-layer layer perceptron.

15. The visual language processor of claim 14, wherein the perceptron consists of two layers.

16. The visual language processor of claim 10, further comprising a patch merge network configured to generate the image-level feature map.

17. The visual language processor of claim 16, wherein the patch merge network comprises adaptive pooling.

18. The visual language processor of claim 10, wherein the language encoder comprises a large language model.

19. The visual language processor of claim 10, wherein the language encoder is trained with prompts comprising a special-purpose image region token.

20. The visual language processor of claim 19, wherein the language encoder is configured to replace the image region token with a corresponding image region embedding.

21. The visual language processor of claim 19, further configured with a learning function comprising an auto-regressive training objective.

22. An image analysis process comprising:
converting an image into a low-resolution feature map;
upsample the low-resolution feature map into a high-resolution feature map;
transforming the high-resolution feature map into an image-level feature map;
transforming the high-resolution feature map through a mask into a region-level feature map for the image; and
mapping the image-level feature map and the region-level feature map into an embedding space of a language encoder.
